(19) United States
(12) Patent Application Publication
(10) Pub. No.: US 2020/0282533 A1
(43) Pub. Date: Sep. 10, 2020

(54) TORQUE WRENCH

(71) Applicant: Hong Ann Tool Industries Co., Ltd., Taichung City (TW)

(72) Inventor: Cheng-Wei SU, Taichung City (TW)

(21) Appl. No.: 16/776,727

(22) Filed: Jan. 30, 2020

(30) Foreign Application Priority Data
Mar. 6, 2019 (TW) 108107483

(51) Int. Cl. B25B 23/142; B25B 23/00

(52) U.S. Cl. CPC B25B 23/1427; B25B 23/0035

(57) ABSTRACT

A torque wrench includes a body, a driving member rotatably mounted in the body, and a torsion control unit. The torsion control unit includes a stopper, a resilient element, and a push rod. The stopper and the resilient element are received in the body. The stopper includes a first end abutting against the driving member. The resilient element includes a first U-shaped plate having a first end, a second end, and an intermediate portion between the first and second ends. The intermediate portion is arcuate and is connected to a second end of the stopper. An opening is defined between the first and second ends of the first U-shaped plate of the resilient element and faces away from the stopper. The push rod is connected to the body and has an end simultaneously abutting against the first and second ends of the first U-shaped plate of the resilient element.

### BACKGROUND OF THE INVENTION

The present invention relates to a torque wrench and, more particularly, to a torque wrench permitting easy adjustment of a torque capacity of the torque wrench.

Taiwan Patent No. 1647075 discloses a torque wrench including an outer tube having an axially extending compartment; a driving member having a driving head on an end thereof and a connecting end on another end thereof, with the driving member rotatably mounted to an end of the outer tube, with the connecting end extending into the compartment; a pressing member slidably received in the compartment and connected to the connecting end; a sleeve mounted between the outer tube and the pressing member; and a torque adjusting device mounted to another end of the outer tube opposite to the driving member, with the torque adjusting device configured for adjusting a torque value.

However, a significant change in the torque value can be achieved when the torque adjusting device undergoes a large rotational movement. In use, the torque adjusting device may have to be rotated one or even several circles to obtain the target torque value, which is troublesome and time-consuming.

Thus, a need exists for a novel torque wrench that mitigates and/or obviates the disadvantages of conventional torque wrenches.

### BRIEF SUMMARY OF THE INVENTION

In a first aspect, a torque wrench according to the present invention includes a body, a driving member rotatably mounted in the body, and a torsion control unit. The torsion control unit includes a stopper, a resilient element, and a push rod. The stopper and the resilient element are received in the body. The stopper includes a first end abutting against the driving member and a second end. The resilient element includes a first U-shaped plate having a first end, a second end, and an intermediate portion between the first end and the second end. The intermediate portion is arcuate and is connected to the second end of the stopper. An opening is defined between the first and second ends of the first U-shaped plate of the resilient element and faces away from the stopper. The push rod is connected to the body and has an end simultaneously abutting against the first and second ends of the first U-shaped plate of the resilient element.

In an example, the first U-shaped plate of the resilient element is made of a shape memory alloy.

In an example, the first U-shaped plate of the resilient element includes an outer, convex surface facing the stopper and an inner, concave surface facing the push rod. The outer, convex surface and the inner, concave surface have a thickness therebetween. The first U-shaped plate of the resilient element includes a first side and a second side opposite to the first side in a diametric direction perpendicular to a longitudinal axis of the push rod. The first side and the second side have a width therebetween. The width is more than two times the thickness.

In an example, the driving member includes an outer periphery surrounding a rotating axis of the driving member. A plurality of positioning grooves is defined in the outer periphery of the driving member and is spaced from each other at regular angular intervals. The first end of the stopper includes a positioning protrusion. The positioning protrusion is releasably engaged in one of the plurality of positioning grooves.

In an example, the push rod includes a rod body, a push member, and a knob. The rod body is rotatably received in the body and includes a first end having a first threaded portion. The push member has a second threaded portion in threading connection with the first threaded portion. The push member simultaneously abuts against the first and second ends of the first U-shaped plate of the resilient element. The knob is securely connected to a second end of the rod body opposite to the push member, permitting joint rotation of the knob and the rod body.

In an example, the body includes a head and a handle. The head includes a rotating groove extending therethrough. The head includes a compartment in a radial direction of the rotating groove. The compartment intercommunicates with the rotating groove and has non-circular cross sections perpendicular to a longitudinal direction of the compartment. The handle has a first end connected to the head and has a through-hole extending from the first end of the handle through a second end of the handle opposite to the first end of the handle. The driving member is received in the rotating groove. The rod body is received in the through-hole. The stopper and the resilient element are received in the compartment. The push member is received in the compartment and has cross sections perpendicular to the longitudinal direction of the compartment. The cross sections of the push member are identical to the non-circular cross sections of the compartment. The knob is located outside of the through-hole of the handle.

In an example, the push rod includes a limiting member mounted around the rod body. The limiting member is disposed on a side of the push member opposite to the resilient element. The push rod includes a pivotal seat mounted around the rod body and securely disposed in the through-hole. The rod body further includes a second end opposite to the first end having the first threaded portion. The second end of the rod body has non-circular cross sections. The knob has a non-circular hole coupled with the second end of the rod body. The handle includes an index at the second end thereof opposite to the head. The knob has a scale along an outer periphery thereof around a longitudinal axis of the rod body. The index points to the scale.

In an example, the resilient element further includes a second U-shaped plate and a third U-shaped plate. The second U-shaped plate is sandwiched between the first and third U-shaped plates. Each of the second and third U-shaped plates is made of a shape memory alloy and includes first and second ends and an arcuate intermediate portion between the first and second ends. The first and second ends of the second U-shaped plate abut against the first and second ends of the first U-shaped plate. The arcuate intermediate portion of the third U-shaped plate abuts against the arcuate intermediate portion of the second U-shaped plate.

In a second aspect, a torque wrench according to the present invention includes a body, a driving member rotatably mounted in the body, and a torsion control unit. The torsional control unit includes a stopper, a resilient element, and a push rod. The stopper and the resilient element are received in the body. The stopper includes a first end abutting against the driving member and a second end. The resilient element includes a plurality of wavy plates each being annular. The plurality of wavy plates is disposed side by side from a position adjacent to the stopper to another position adjacent to the push rod. The plurality of wavy plates is connected to one another. The resilient element has a first end abutting against the second end of the stopper. The push rod is connected to the body and abuts against a second end of the resilient element opposite to the stopper.

In an example, the resilient element is made of a shape memory alloy.

In an example, the driving member includes an outer periphery surrounding a rotating axis of the driving member. A plurality of positioning grooves is defined in the outer periphery of the driving member and is spaced from each other at regular angular intervals. The first end of the stopper includes a positioning protrusion. The positioning protrusion is releasably engaged in one of the plurality of positioning grooves.

In an example, the push rod includes a rod body, a push member, and a knob. The rod body is rotatably received in the body and includes a first end having a first threaded portion. The push member has a second threaded portion in threading connection with the first threaded portion. The push member abuts against the second end of the resilient element. The knob is securely connected to a second end of the rod body opposite to the push member, permitting joint rotation of the knob and the rod body.

In an example, the body includes a head and a handle. The head includes a rotating groove extending therethrough. The head includes a compartment in a radial direction of the rotating groove. The compartment intercommunicates with the rotating groove and has non-circular cross sections perpendicular to a longitudinal direction of the compartment. The handle has a first end connected to the head and has a through-hole extending from the first end of the handle through a second end of the handle opposite to the first end of the handle. The driving member is received in the rotating groove. The rod body is received in the through-hole. The stopper and the resilient element are received in the compartment. The push member is received in the compartment and has cross sections perpendicular to the longitudinal direction of the compartment. The cross sections of the push member are identical to the non-circular cross sections of the compartment. The knob is located outside of the through-hole of the handle.

In an example, the push rod includes a limiting member mounted around the rod body. The limiting member is disposed on a side of the push member opposite to the resilient element. The push rod includes a pivotal seat mounted around the rod body and securely disposed in the through-hole. The rod body further includes a second end opposite to the first end having the first threaded portion. The second end of the rod body has non-circular cross sections. The knob has a non-circular hole coupled with the second end of the rod body. The handle includes an index at the second end thereof opposite to the head. The knob has a scale along an outer periphery thereof around a longitudinal axis of the rod body. The index points to the scale.

In a third aspect, a torque wrench according to the present invention includes a body, a driving member rotatably mounted in the body, and a torsion control unit. The torsion control unit includes a stopper, a resilient element, and a push rod. The stopper and the resilient element are received in the body. The stopper includes a first end abutting against the driving member and a second end. The resilient element is a bowl-shaped member includes a first end connected to the second end of the stopper and an open second end facing away from the stopper. The bowl-shaped member includes a plurality of slits extending from an annular end face of the open second end towards but spaced from the first end of the bowl-shaped member. The push rod is connected to the body and presses against the annular end face of the open second end of the bowl-shaped member.

In an example, the resilient element is made of a shape memory alloy.

In an example, the driving member includes an outer periphery surrounding a rotating axis of the driving member. A plurality of positioning grooves is defined in the outer periphery of the driving member and is spaced from each other at regular angular intervals. The first end of the stopper includes a positioning protrusion. The positioning protrusion is releasably engaged in one of the plurality of positioning grooves.

In an example, the push rod includes a rod body, a push member, and a knob. The rod body is rotatably received in the body and includes a first end having a first threaded portion. The push member has a second threaded portion in threading connection with the first threaded portion. The push member abuts against the second end of the resilient element. The knob is securely connected to a second end of the rod body opposite to the push member, permitting joint rotation of the knob and the rod body.

In an example, the body includes a head and a handle. The head includes a rotating groove extending therethrough. The head includes a compartment in a radial direction of the rotating groove. The compartment intercommunicates with the rotating groove and has non-circular cross sections perpendicular to a longitudinal direction of the compartment. The handle has a first end connected to the head and has a through-hole extending from the first end of the handle through a second end of the handle opposite to the first end of the handle. The driving member is received in the rotating groove. The rod body is received in the through-hole. The stopper and the resilient element are received in the compartment. The push member is received in the compartment and has cross sections perpendicular to the longitudinal direction of the compartment. The cross sections of the push member are identical to the non-circular cross sections of the compartment. The knob is located outside of the through-hole of the handle.

In an example, the push rod includes a limiting member mounted around the rod body. The limiting member is disposed on a side of the push member opposite to the resilient element. The push rod includes a pivotal seat mounted around the rod body and securely disposed in the through-hole. The rod body further includes a second end opposite to the first end having the first threaded portion. The second end of the rod body has non-circular cross sections. The knob has a non-circular hole coupled with the second end of the rod body. The handle includes an index at the second end thereof opposite to the head. The knob has a scale along an outer periphery thereof around a longitudinal axis of the rod body. The index points to the scale.

The present invention will become clearer in light of the following detailed description of illustrative embodiments of this invention described in connection with the drawings.

### DESCRIPTION OF THE DRAWINGS

FIG. 1 is a perspective view of a torque wrench of a first embodiment according to the present invention.

FIG. 2 is an exploded, perspective view of the torque wrench of FIG. 1.

FIG. 3 is a cross sectional view of the torque wrench of FIG. 1.

FIG. 4 is another cross sectional view of the torque wrench of FIG. 1.

FIG. 5 is a perspective view of a torque wrench of a second embodiment according to the present invention.

FIG. 6 is a top view of the torque wrench of FIG. 5.

FIG. 7 is a perspective view of a torque wrench of a third embodiment according to the present invention.

FIG. 8 is a perspective view of a torque wrench of a fourth embodiment according to the present invention.

FIG. 9 is an exploded, perspective view of the torque wrench of FIG. 8.

FIG. 10 is a cross sectional view of the torque wrench of FIG. 8.

FIG. 11 is an exploded, perspective view of a torque wrench of a fifth embodiment according to the present invention.

FIG. 12 is a cross sectional view of the torque wrench of FIG. 11.

FIG. 13 is an exploded, perspective view of a torque wrench of a sixth embodiment according to the present invention.

FIG. 14 is a cross sectional view of the torque wrench of FIG. 13.

### DETAILED DESCRIPTION OF THE INVENTION

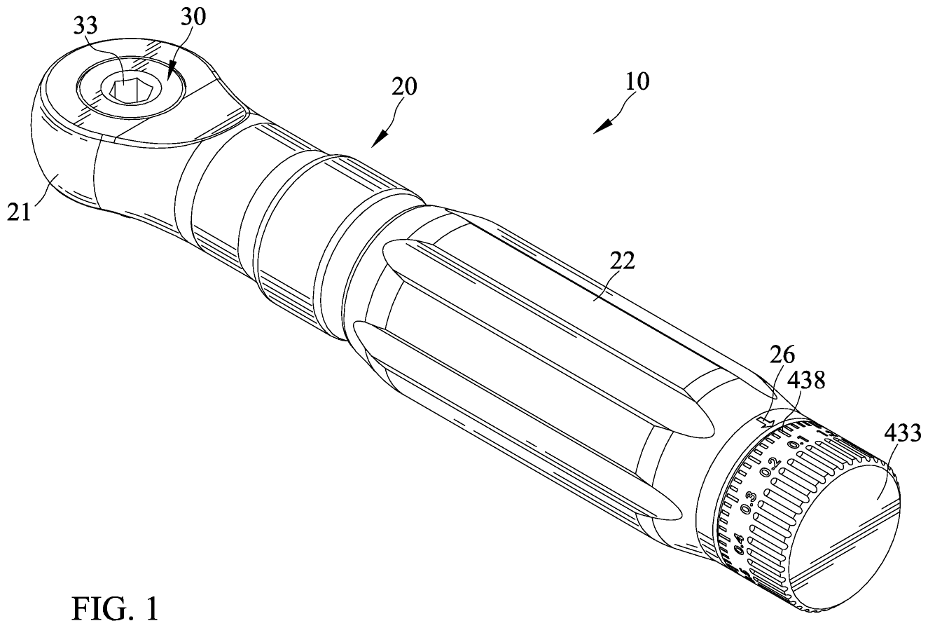

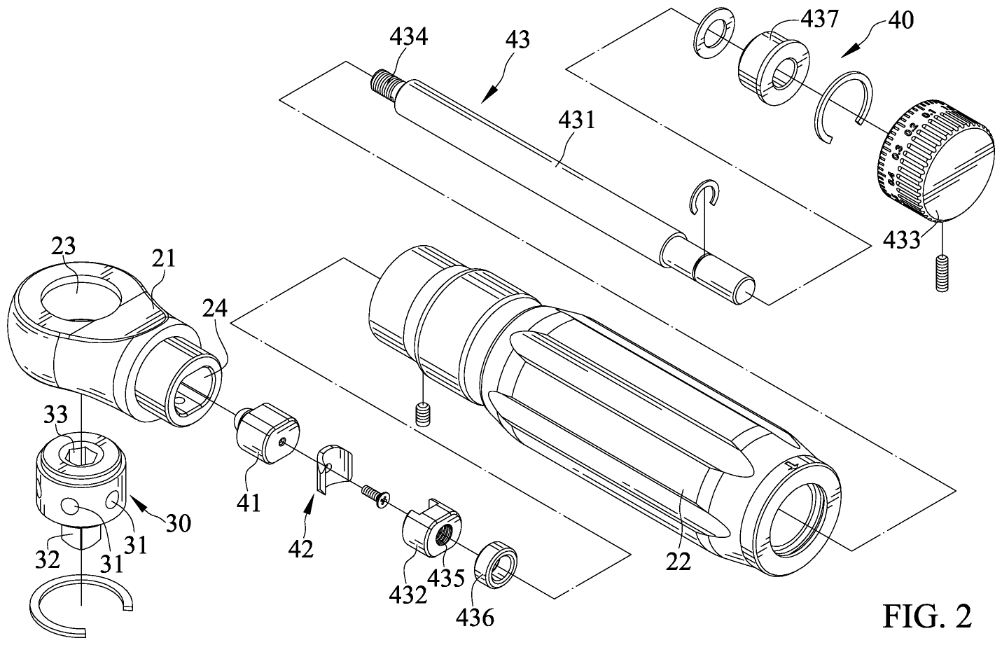

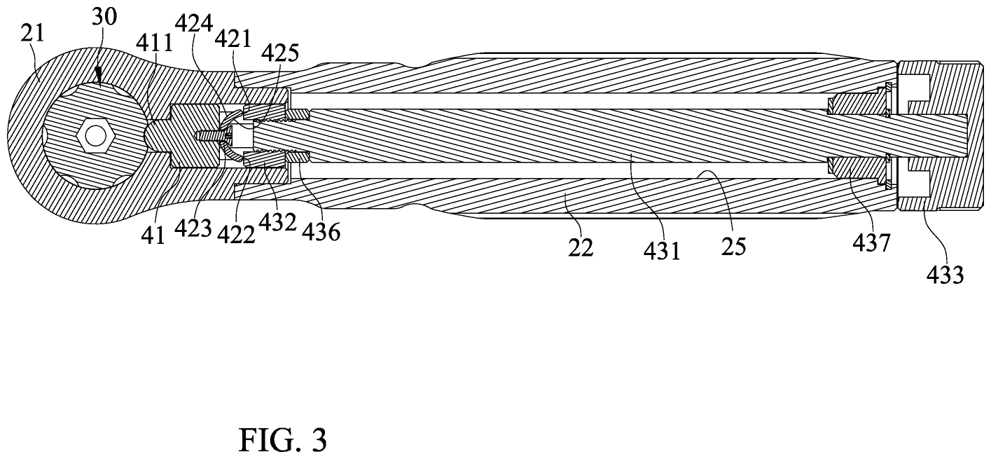

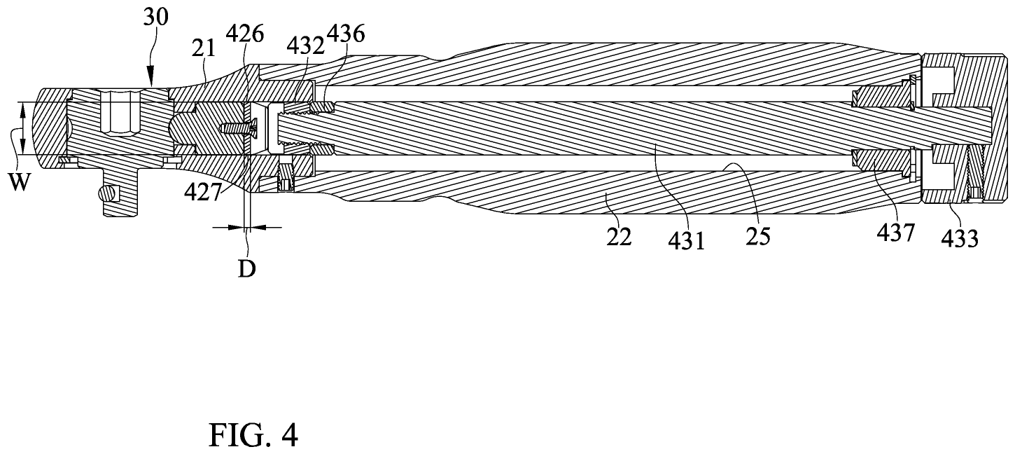

With reference to FIGS. 1-4, a torque wrench 10 of a first embodiment according to the present invention includes a body 20, a driving member 30, and a torque control unit 40. The body 20 includes a head 21 and a handle 22. The head 21 includes a rotating groove 23 extending therethrough. The head 21 includes a compartment 24 in a radial direction of the rotating groove 23. The compartment 24 intercommunicates with the rotating groove 23 and has non-circular (elliptic in this embodiment) cross sections perpendicular to a longitudinal direction of the compartment 24. The handle 22 has a first end connected to the head 21 and has a through-hole 25 extending from the first end of the handle 22 through a second end of the handle 22 opposite to the first end of the handle 22. The handle 22 includes an index 26 at the second end thereof opposite to the head 21.

The driving member 30 is rotatably mounted in the rotating groove 23 of the body 20. The driving member 30 includes an outer periphery surrounding a rotating axis of the driving member 30. A plurality of positioning grooves 31 is defined in the outer periphery of the driving member 30 and is spaced from each other at regular angular intervals. The driving member 30 includes a driving column 32 protruding from a side thereof. The driving column 32 has square cross sections. A driving groove 33 is defined in another side of the driving member 30 opposite to the driving column 32. The driving groove 33 is hexagonal in cross section.

The torsion control unit 40 including a stopper 41, a resilient element 42, and a push rod 43. The stopper 41 and the resilient element 42 are received in the compartment 24 of the body 20. The stopper 41 includes a first end abutting against the driving member 30 and a second end. The first end of the stopper 41 includes a positioning protrusion 411. The positioning protrusion 411 is releasably engaged in one of the plurality of positioning grooves 31.

The resilient element 42 includes a first U-shaped plate 420 made of a shape memory alloy. The first U-shaped plate 420 has a first end 421, a second end 422, and an intermediate portion 423 between the first end 421 and the second end 422. The intermediate portion 423 is arcuate and is connected to the second end of the stopper 41. An opening is defined between the first and second ends 421 and 422 of the first U-shaped plate 420 of the resilient element 42 and faces away from the stopper 41.

The push rod 43 is connected to the body 20 and has an end simultaneously abutting against the first and second ends 421 and 422 of the first U-shaped plate 420 of the resilient element 42. The first U-shaped plate 420 of the resilient element 42 includes an outer, convex surface 424 facing the stopper 41 and an inner, concave surface 425 facing the push rod 43. The outer, convex surface 424 and the inner, concave surface 425 have a thickness D therebetween. The first U-shaped plate 420 of the resilient element 42 includes a first side 426 and a second side 427 opposite to the first side 426 in a diametric direction perpendicular to a longitudinal axis of the push rod 43. The first side 426 and the second side 427 have a width W therebetween. The width W is more than two times the thickness D.

The push rod 43 includes a rod body 431, a push member 432, and a knob 433. The rod body 431 is rotatably received in the through-hole 25 of the body 20 and includes a first end having a first threaded portion 434. The rod body 431 further includes a second end opposite to the first end having the first threaded portion 434. The second end of the rod body 431 has non-circular cross sections. The push member 432 has a second threaded portion 435 in threading connection with the first threaded portion 434. The push member 432 is received in the compartment 24 and has non-circular cross sections perpendicular to the longitudinal direction of the compartment 24. The push member 432 simultaneously abuts against the first and second ends 421 and 422 of the first U-shaped plate 420 of the resilient element 42. The knob 433 is securely connected to the second end of the rod body 431 opposite to the push member 432, permitting joint rotation of the knob 433 and the rod body 431. The knob 433 has a non-circular hole coupled with the second end of the rod body 431 and is located outside of the through-hole 25.

The push rod 43 includes a limiting member 436 mounted around the rod body 431. The limiting member 436 is disposed on a side of the push member 432 opposite to the resilient element 42. The push rod 43 includes a pivotal seat 437 mounted around the rod body 431 and securely disposed in the through-hole 25. The knob 433 has a scale 438 along an outer periphery thereof around a longitudinal axis of the rod body 431. The index 26 points to the scale 438.

The torque capacity of the torque wrench 10 can be rapidly adjusted by the above structure. In use, the wrench 10 can be used to drive an object through the driving member 30. When the driving torque is greater than a preset torque value, the resilient element 42 is compressed and deforms, such that the stopper 41 cannot stop the driving member 30. As a result, the driving member 30 rotates relative to the body 20 but cannot drive the object. When it is desired to adjust the preset torque value, the knob 433 can be rotated to move the push member 432 towards or away from the driving member 30 through the threading connection. The elastic returning force of the resilient element 42 is varied to change the preset torque value of the wrench 10. Since the resilient element 42 is made of a shape memory alloy in the form of a plate, the adjustment can be rapidly achieved by rotating the knob 433 through a small degree.

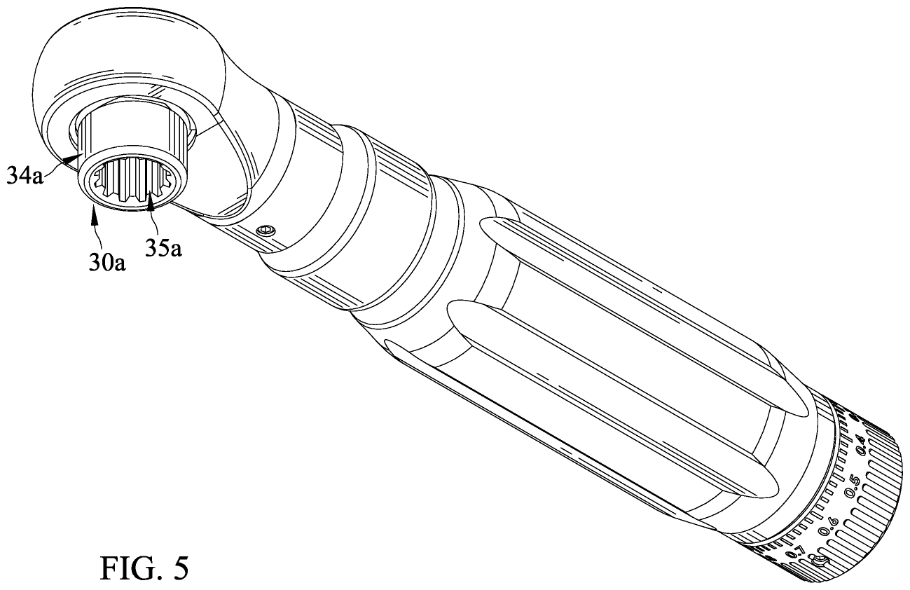

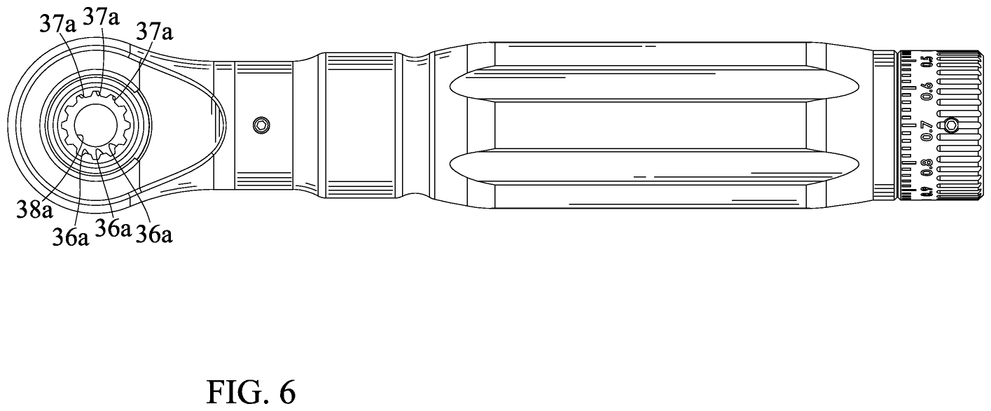

FIGS. 5 and 6 show a torque wrench of a second embodiment according to the present invention. The second embodiment is substantially the same as the first embodiment except for that the driving member 30a includes a driving socket 34a protruding from a side thereof. The driving socket 34a includes a coupling groove 35a in an end face thereof. The coupling groove 35a includes an inner periphery having a plurality of protrusions 36a and a plurality of grooves 37a. The plurality of protrusions 36a and the plurality of grooves 37a, extend in a longitudinal direction of the coupling groove 35a, have the same number, and are alternately disposed. The coupling groove 35a includes a bottom wall. A through-hole 38a extends through the bottom wall in the longitudinal direction of the coupling groove 35a and extends to another side of the driving member 30a opposite to the driving socket 34a.

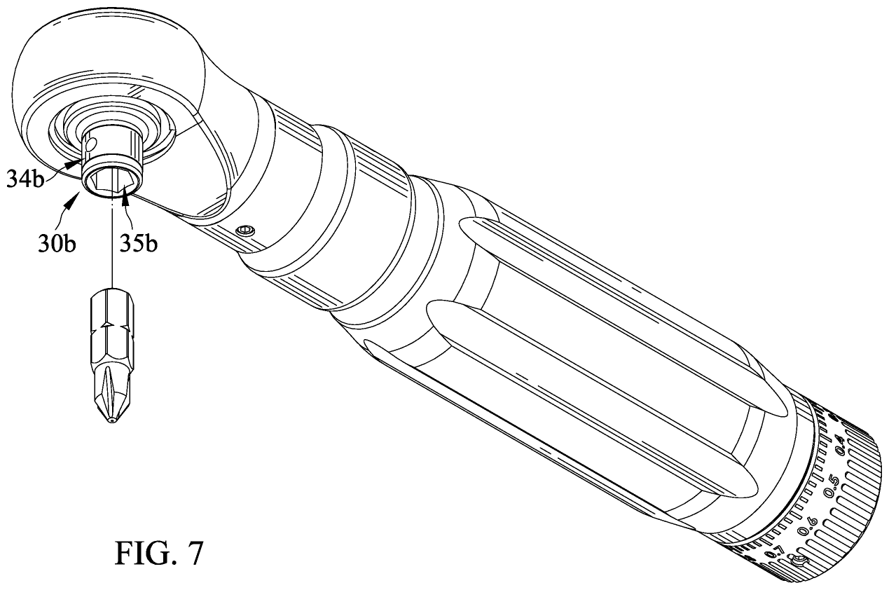

FIG. 7 shows a torque wrench of a third embodiment according to the present invention. The third embodiment is substantially the same as the first embodiment except for that the driving member 30b includes a driving socket 34b protruding from a side thereof, the driving socket 34b includes a coupling groove 35b in an end face thereof, and the coupling groove 35b is hexagonal in cross section.

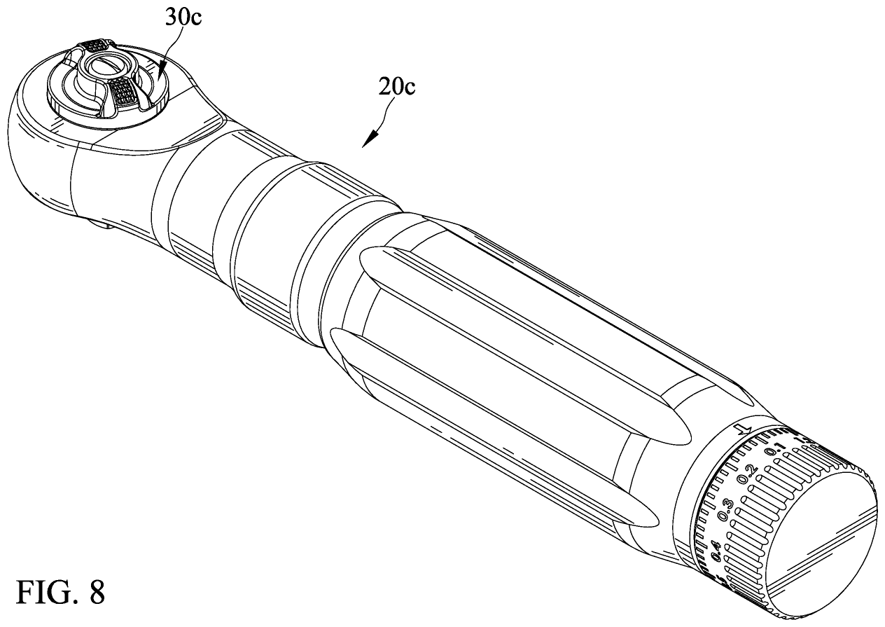

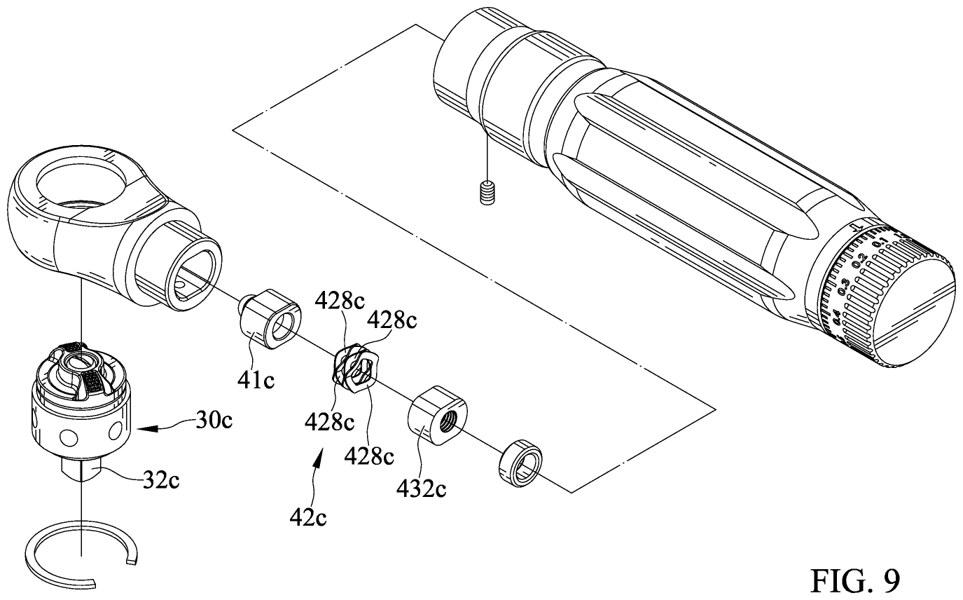

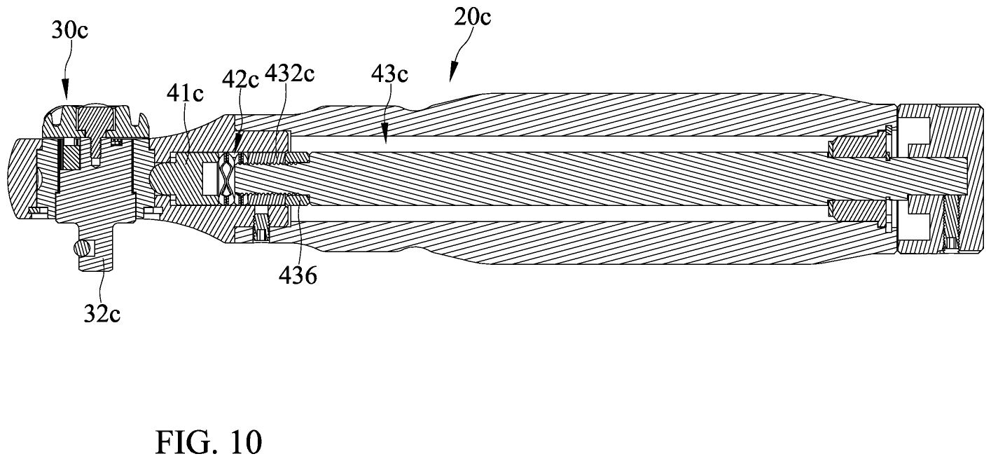

FIGS. 8-10 show a torque wrench of a fourth embodiment according to the present invention. The fourth embodiment is substantially the same as the first embodiment except for that the resilient element 42c is a wavy spring made of a shape memory alloy. The resilient element 42c includes a plurality of wavy plates 428c each being annular. The plurality of wavy plates 428c is disposed side by side from a position adjacent to the stopper 41c to another position adjacent to the push rod 43c. The plurality of wavy plates 428c is connected to one another. The resilient element 42c has a first end abutting against the second end of the stopper 41c. The push rod 43c is connected to the body 20c and abuts against a second end of the resilient element 42c opposite to the stopper 41c. The driving member 30c includes a driving column 32c protruding from a side thereof. The driving column 32c has square cross sections and can provide a ratchet wheel function for driving an object in a single direction.

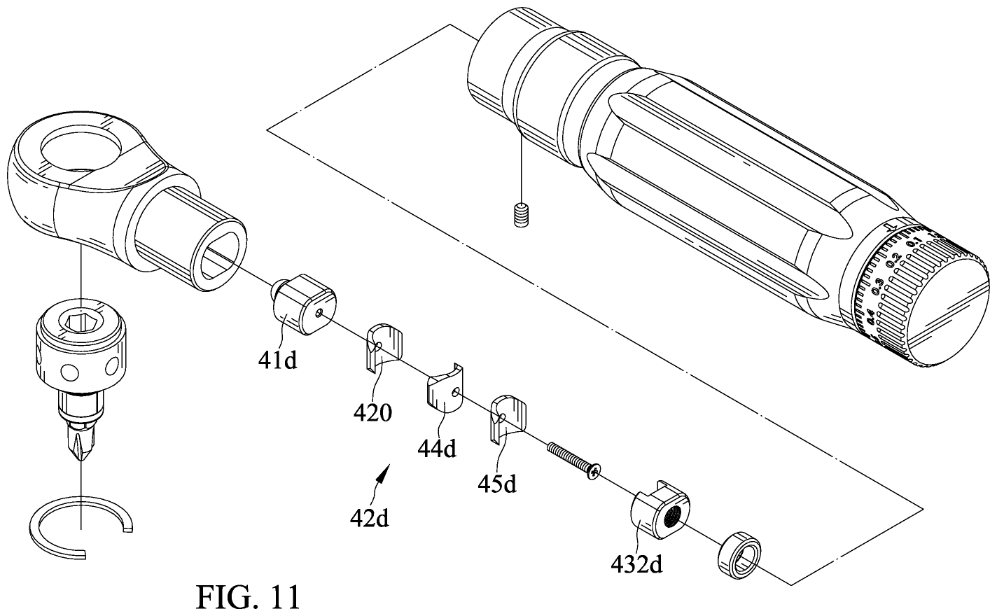

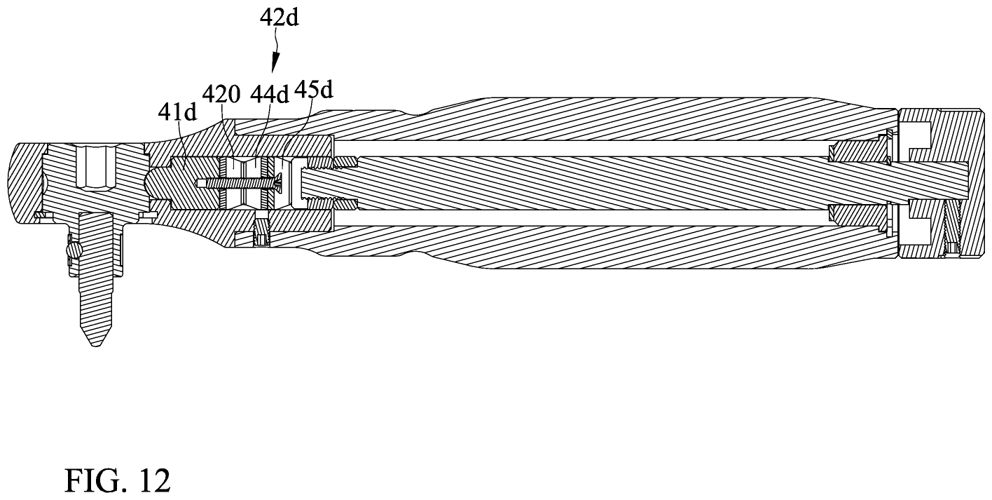

FIGS. 11 and 12 show a torque wrench of a fifth embodiment according to the present invention. The fifth embodiment is substantially the same as the first embodiment except for that the resilient element 42d further includes a second U-shaped plate 44d and a third U-shaped plate 45d. The second U-shaped plate 44d is sandwiched between the first U-shaped plate 420d and third U-shaped plate 45d. Each of the second and third U-shaped plates 44d and 45d is made of a shape memory alloy and includes first and second ends and an arcuate intermediate portion between the first and second ends. The first and second ends of the second U-shaped plate 44d abut against the first and second ends 421 and 422 of the first U-shaped plate 420d. The arcuate intermediate portion of the third U-shaped plate 45d abuts against the arcuate intermediate portion of the second U-shaped plate 44d.

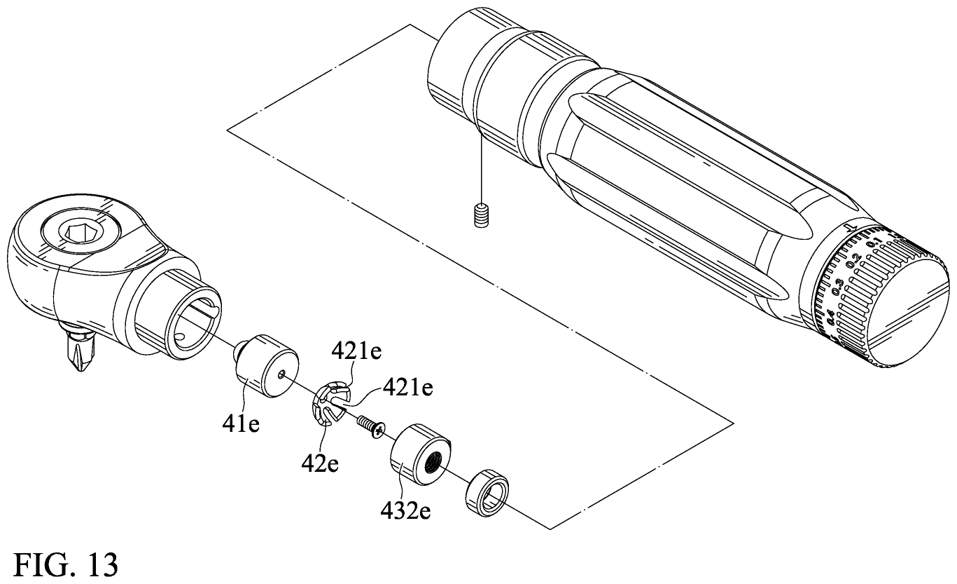

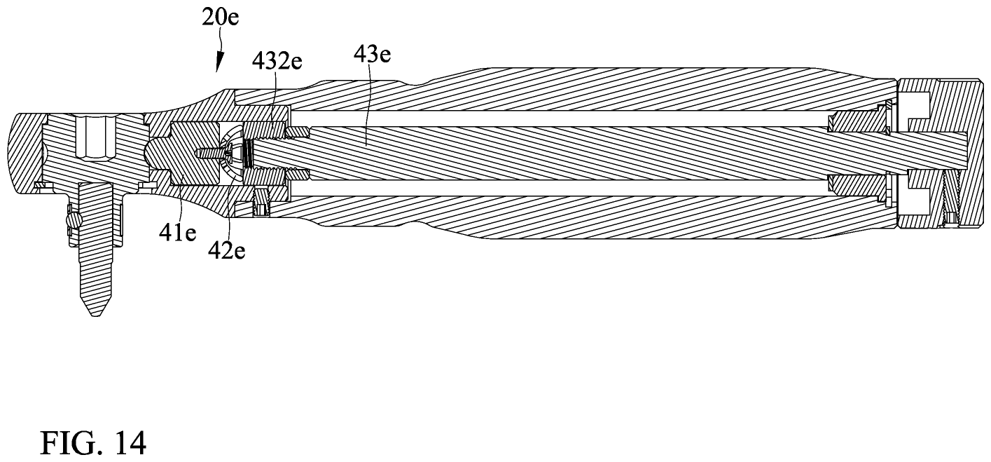

FIGS. 13 and 14 show a torque wrench of a sixth embodiment according to the present invention. The sixth embodiment is substantially the same as the first embodiment except for that wherein the resilient element 42e is a bowl-shaped member made of a shape memory alloy. The bowl-shaped member made includes a first end connected to the second end of the stopper 41e and an open second end facing away from the stopper 41. The bowl-shaped member includes a plurality of slits 429e extending from an annular end face of the open second end towards but spaced from the first end of the bowl-shaped member. The push rod 43e is connected to the body 20e and presses against the annular end face of the open second end of the bowl-shaped member.

In view of the foregoing, the torque wrench 10 according to the present invention permits easy adjustment of the torque capacity through simple operation.

Although specific embodiments have been illustrated and described, numerous modifications and variations are still possible without departing from the scope of the invention. The scope of the invention is limited by the accompanying claims.

1. A torque wrench comprising:
a body;
a driving member rotatably mounted in the body; and
a torsion control unit including a stopper, a resilient element, and a push rod, wherein the stopper and the resilient element are received in the body, wherein the stopper includes a first end abutting against the driving member and a second end, wherein the resilient element includes a first U-shaped plate having a first end, a second end, and an intermediate portion between the first end and the second end, wherein the intermediate portion is arcuate and is connected to the second end of the stopper, wherein an opening is defined between the first and second ends of the first U-shaped plate of the resilient element and faces away from the stopper, wherein the push rod is connected to the body and has an end simultaneously abutting against the first and second ends of the first U-shaped plate of the resilient element.

2. The torque wrench as claimed in claim 1, wherein the first U-shaped plate of the resilient element is made of a shape memory alloy.

3. The torque wrench as claimed in claim 2, wherein the first U-shaped plate of the resilient element includes an outer, convex surface facing the stopper and an inner, concave surface facing the push rod, wherein the outer, convex surface and the inner, concave surface have a thickness therebetween, wherein the first U-shaped plate of the resilient element includes a first side and a second side opposite to the first side in a diametric direction perpendicular to a longitudinal axis of the push rod, wherein the first side and the second side have a width therebetween, and wherein the width is more than two times the thickness.

4. The torque wrench as claimed in claim 3, wherein the driving member includes an outer periphery surrounding a rotating axis of the driving member, wherein a plurality of positioning grooves is defined in the outer periphery of the driving member and is spaced from each other at regular angular intervals, wherein the first end of the stopper includes a positioning protrusion, and wherein the positioning protrusion is releasably engaged in one of the plurality of positioning grooves.

5. The torque wrench as claimed in claim 1, wherein the push rod includes a rod body, a push member, and a knob, wherein the rod body is rotatably received in the body and includes a first end having a first threaded portion, wherein the push member has a second threaded portion in threading connection with the first threaded portion, wherein the push member simultaneously abuts against the first and second ends of the first U-shaped plate of the resilient element, and wherein the knob is securely connected to a second end of the rod body opposite to the push member, permitting joint rotation of the knob and the rod body.

6. The torque wrench as claimed in claim 5, wherein the body includes a head and a handle, wherein the head includes a rotating groove extending therethrough, wherein the head includes a compartment in a radial direction of the rotating groove, wherein the compartment intercommunicates with the rotating groove and has non-circular cross sections perpendicular to a longitudinal direction of the compartment, wherein the handle has a first end connected to the head and has a through-hole extending from the first end of the handle through a second end of the handle opposite to the first end of the handle, wherein the driving member is received in the rotating groove, wherein the rod body is received in the through-hole, wherein the stopper and the resilient element are received in the compartment, wherein the push member is received in the compartment and has cross sections perpendicular to the longitudinal direction of the compartment, wherein the cross sections of the push member are identical to the non-circular cross sections of the compartment, and wherein the knob is located outside of the through-hole of the handle.

7. The torque wrench as claimed in claim 6, wherein the push rod includes a limiting member mounted around the rod body, wherein the limiting member is disposed on a side of the push member opposite to the resilient element, wherein the push rod includes a pivotal seat mounted around the rod body and securely disposed in the through-hole, wherein the rod body further includes a second end opposite to the first end having the first threaded portion, wherein the second end of the rod body has non-circular cross sections, wherein the knob has a non-circular hole coupled with the second end of the rod body, wherein the handle includes an index at the second end thereof opposite to the head, wherein the knob has a scale along an outer periphery thereof around a longitudinal axis of the rod body, and wherein the index points to the scale.

8. The torque wrench as claimed in claim 3, wherein the resilient element further includes a second U-shaped plate and a third U-shaped plate, wherein the second U-shaped plate is sandwiched between the first and third U-shaped plates, wherein each of the second and third U-shaped plates is made of a shape memory alloy and includes first and second ends and an arcuate intermediate portion between the first and second ends, wherein the first and second ends of the second U-shaped plate abut against the first and second ends of the first U-shaped plate, wherein the arcuate intermediate portion of the third U-shaped plate abuts against the arcuate intermediate portion of the second U-shaped plate.

9. A torque wrench comprising:
a body;
a driving member rotatably mounted in the body; and
a torsion control unit including a stopper, a resilient element, and a push rod, wherein the stopper and the resilient element are received in the body, wherein the stopper includes a first end abutting against the driving member and a second end, wherein the resilient element includes a plurality of wavy plates each being annular, wherein the plurality of wavy plates is disposed side by side from a position adjacent to the stopper to another position adjacent to the push rod, wherein the plurality of wavy plates is connected to one another, wherein the resilient element has a first end abutting against the second end of the stopper, and wherein the push rod is connected to the body and abuts against a second end of the resilient element opposite to the stopper.

10. The torque wrench as claimed in claim 9, wherein the resilient element is made of a shape memory alloy.

11. The torque wrench as claimed in claim 10, wherein the driving member includes an outer periphery surrounding a rotating axis of the driving member, wherein a plurality of positioning grooves is defined in the outer periphery of the driving member and is spaced from each other at regular angular intervals, wherein the first end of the stopper includes a positioning protrusion, and wherein the positioning protrusion is releasably engaged in one of the plurality of positioning grooves.

12. The torque wrench as claimed in claim 9, wherein the push rod includes a rod body, a push member, and a knob, wherein the rod body is rotatably received in the body and includes a first end having a first threaded portion, wherein the push member has a second threaded portion in threading connection with the first threaded portion, wherein the push member abuts against the second end of the resilient element, and wherein the knob is securely connected to a second end of the rod body opposite to the push member, permitting joint rotation of the knob and the rod body.

13. The torque wrench as claimed in claim 12, wherein the body includes a head and a handle, wherein the head includes a rotating groove extending therethrough, wherein the head includes a compartment in a radial direction of the rotating groove, wherein the compartment intercommunicates with the rotating groove and has non-circular cross sections perpendicular to a longitudinal direction of the compartment, wherein the handle has a first end connected to the head and has a through-hole extending from the first end of the handle through a second end of the handle opposite to the first end of the handle, wherein the driving member is received in the rotating groove, wherein the rod body is received in the through-hole, wherein the stopper and the resilient element are received in the compartment, wherein the push member is received in the compartment and has cross sections perpendicular to the longitudinal direction of the compartment, wherein the cross sections of the push member are identical to the non-circular cross sections of the compartment, and wherein the knob is located outside of the through-hole of the handle.

14. The torque wrench as claimed in claim 13, wherein the push rod includes a limiting member mounted around the rod body, wherein the limiting member is disposed on a side of the push member opposite to the resilient element, wherein the push rod includes a pivotal seat mounted around the rod body and securely disposed in the through-hole, wherein the rod body further includes a second end opposite to the first end having the first threaded portion, wherein the second end of the rod body has non-circular cross sections, wherein the knob has a non-circular hole coupled with the second end of the rod body, wherein the handle includes an index at the second end thereof opposite to the head, wherein the knob has a scale along an outer periphery thereof around a longitudinal axis of the rod body, and wherein the index points to the scale.

15. A torque wrench comprising:
a body;
a driving member rotatably mounted in the body; and
a torsion control unit including a stopper, a resilient element, and a push rod, wherein the stopper and the resilient element are received in the body, wherein the stopper includes a first end abutting against the driving member and a second end, wherein the resilient element is a bowl-shaped member includes a first end connected to the second end of the stopper and an open second end facing away from the stopper, wherein the bowl-shaped member includes a plurality of slits extending from an annular end face of the open second end towards but spaced from the first end of the bowl-shaped member, and wherein the push rod is connected to the body and presses against the annular end face of the open second end of the bowl-shaped member.

16. The torque wrench as claimed in claim 15, wherein the resilient element is made of a shape memory alloy.

17. The torque wrench as claimed in claim 16, wherein the driving member includes an outer periphery surrounding a rotating axis of the driving member, wherein a plurality of positioning grooves is defined in the outer periphery of the driving member and is spaced from each other at regular angular intervals, wherein the first end of the stopper includes a positioning protrusion, and wherein the positioning protrusion is releasably engaged in one of the plurality of positioning grooves.

18. The torque wrench as claimed in claim 17, wherein the push rod includes a rod body, a push member, and a knob, wherein the rod body is rotatably received in the body and includes a first end having a first threaded portion, wherein the push member has a second threaded portion in threading connection with the first threaded portion, wherein the push member abuts against the second end of the resilient element, and wherein the knob is securely connected to a second end of the rod body opposite to the push member, permitting joint rotation of the knob and the rod body.

19. The torque wrench as claimed in claim 18, wherein the body includes a head and a handle, wherein the head includes a rotating groove extending therethrough, wherein the head includes a compartment in a radial direction of the rotating groove, wherein the compartment intercommunicates with the rotating groove and has non-circular cross sections perpendicular to a longitudinal direction of the compartment, wherein the handle has a first end connected to the head and has a through-hole extending from the first end of the handle through a second end of the handle opposite to the first end of the handle, wherein the driving member is received in the rotating groove, wherein the rod body is received in the through-hole, wherein the stopper and the resilient element are received in the compartment, wherein the push member is received in the compartment and has cross sections perpendicular to the longitudinal direction of the compartment, wherein the cross sections of the push member are identical to the non-circular cross sections of the compartment, and wherein the knob is located outside of the through-hole of the handle.

20. The torque wrench as claimed in claim 19, wherein the push rod includes a limiting member mounted around the rod body, wherein the limiting member is disposed on a side of the push member opposite to the resilient element, wherein the push rod includes a pivotal seat mounted around the rod body and securely disposed in the through-hole, wherein the rod body further includes a second end opposite to the first end having the first threaded portion, wherein the second end of the rod body has non-circular cross sections, wherein the knob has a non-circular hole coupled with the second end of the rod body, wherein the handle includes an index at the second end thereof opposite to the head, wherein the knob has a scale along an outer periphery thereof around a longitudinal axis of the rod body, and wherein the index points to the scale.
